(19) United States
(12) Patent Application Publication
(10) Pub. No.: US 2015/0188103 A1
(43) Pub. Date: Jul. 2, 2015

(54) BATTERY PACK

(71) Applicant: SANYO Electric Co., Ltd., Osaka (JP)

(72) Inventors: Keisuke MINAMI, Kakogawa-shi (JP); Toyoki FUJIHARA, Kanzaki-gun (JP)

(21) Appl. No.: 14/582,976

(22) Filed: Dec. 24, 2014

(30) Foreign Application Priority Data
Dec. 26, 2013 (JP) 2013-268674

(51) Int. Cl. H01M 2/10; H01M 2/04; H01M 2/02; H01M 10/0525; H01M 10/0567

(52) U.S. Cl. CPC H01M 2/1077; H01M 10/0525; H01M 10/0567; H01M 2/0237; H01M 2/043; H01M 2300/0025; H01M 2220/20

(57) ABSTRACT

A battery pack is provided in which a plurality of rectangular secondary batteries are layered with a spacer therebetween. The rectangular secondary battery has a rectangular outer housing that houses a winding electrode assembly and a non-aqueous electrolyte including lithium fluorosulfonic acid, the rectangular outer housing has a bottom, a pair of large-area side walls, and a pair of small-area side walls, and the spacer has a body section, a lower wall section placed to oppose the bottom of the rectangular outer housing, and a pair of side wall sections placed to oppose the small-area side walls of the rectangular outer housing.

### PRIORITY INFORMATION

This application claims priority to Japanese Patent Application No. 2013-268674, filed on Dec. 26, 2013, which is incorporated herein by reference in its entirety.

### BACKGROUND

1. Technical Field

The present invention relates to a battery pack which includes a plurality of rectangular secondary batteries having a non-aqueous electrolyte.

2. Related Art

In recent years, a rectangular secondary battery having a high energy density is used for a driving power supply or the like for a hybrid electric vehicle (PHEV, HEV), or an electric vehicle. In such a driving power supply or the like, a plurality of the rectangular secondary batteries are used being connected in series, in parallel, or in serial-parallel, to form a battery pack. A demand for higher performance is growing higher for the rectangular secondary battery used for the driving power supply or the like.

JP 2013-152956 A discloses, as a technique for providing a rectangular secondary battery in which an initial charge/discharge capacity, an input/output characteristic, and an impedance characteristic are improved, a technique for including fluorosulfonic acid salt in the non-aqueous solvent, and also including a particular compound.

JP 2013-152956 A describes a technique related to a rectangular secondary battery, but does not mention anything in relation to a battery pack which uses a plurality of the rectangular secondary batteries. An advantage of the present invention is that a battery pack is provided which includes a plurality of rectangular secondary batteries having an improved battery characteristic.

### SUMMARY

According to one aspect of the present invention, there is provided a battery pack in which a plurality of rectangular secondary batteries are layered between a pair of end plates with an insulating spacer therebetween, wherein the rectangular secondary battery comprises: a positive electrode plate including a positive electrode active material to and from which lithium ions may be introduced and extracted; a negative electrode plate including a negative electrode active material to and from which lithium ions may be introduced and extracted; a flat-shaped electrode assembly in which the positive electrode plate and the negative electrode plate are layered with a separator therebetween; a non-aqueous electrolyte including lithium fluorosulfonic acid; a rectangular outer housing that has an opening and that houses the electrode assembly and the non-aqueous electrolyte; and a sealing plate that seals the opening, the rectangular outer housing comprising a bottom, a pair of large-area side walls, and a pair of small-area side walls having a smaller area than the large-area side wall, and the spacer comprising a body section placed between the large-area side walls of adjacent rectangular secondary batteries, a lower wall section extending from the body section in a vertical direction with respect to the body section and placed to oppose the bottom of the rectangular outer housing, and a pair of side wall sections extending from the body section in a vertical direction with respect to the body section and placed to respectively oppose the pair of the small-area side walls of the rectangular outer housing.

According to another aspect of the present invention, preferably, the spacer further comprises an upper wall section extending from the body section in a vertical direction with respect to the body section and placed to oppose the sealing plate.

According to another aspect of the present invention, preferably, a plurality of projections extending in a width direction of the body section are provided on one surface of the body section, and a tip surface of the projection presses the rectangular secondary battery.

According to another aspect of the present invention, preferably, an area where one surface side of the spacer presses the large-area side wall of the rectangular secondary battery opposing the one surface is smaller than an area where the other surface side of the spacer presses the large-area side wall of the rectangular secondary battery opposing the other surface.

According to another aspect of the present invention, preferably, the projection provided on the body section protrudes in a direction opposite from a direction of protrusion of the side wall section provided on the body section.

### Advantages

According to a battery pack of various aspects of the present invention, a spacer has a lower wall section and a pair of side wall sections, and a non-aqueous electrolyte of the rectangular secondary battery includes lithium fluorosulfonic acid. With such a configuration, a battery pack can be provided in which damage to an outer housing of the rectangular secondary battery can be prevented, the battery characteristic of each rectangular secondary battery can be improved, and in particular, a superior high-temperature storage characteristic can be realized.

### BRIEF DESCRIPTION OF THE DRAWINGS

FIG. 1 is a perspective diagram of a rectangular secondary battery used in a battery pack according to a preferred embodiment of the present invention.

FIG. 2A is a cross sectional diagram along a line IIA-IIA of FIG. 1.

FIG. 2B is a cross sectional diagram along a line IIB-IIB of FIG. 2A.

FIG. 3A is a plan view of a positive electrode plate used in the rectangular secondary battery.

FIG. 3B is a plan view of a negative electrode plate used in the rectangular secondary battery.

FIG. 4A is a plan view of a battery pack according to a preferred embodiment of the present invention.

FIG. 4B is a side view of a battery pack 30 according to a preferred embodiment of the present invention.

FIG. 5A is a front view of a spacer used in a battery pack according to a preferred embodiment of the present invention.

FIG. 5B is a back view of the spacer used in the battery pack according to a preferred embodiment of the present invention.

FIG. 5C is a bottom view of the spacer used in the battery pack according to a preferred embodiment of the present invention.

FIG. 5D is a plan view of the spacer used in the battery pack according to a preferred embodiment of the present invention.

FIG. 5E is a right side view of the spacer used in the battery pack according to a preferred embodiment of the present invention.

FIG. 5F is a left side view of the spacer used in the battery pack according to a preferred embodiment of the present invention.

FIG. 6A is a partial cross sectional diagram along a line VIA-VIA of FIG. 4A.

FIG. 6B is a partial cross sectional diagram along a line VIB-VIB of FIG. 4B.

FIG. 7A is a diagram showing a spacer and a rectangular secondary battery of a first alternative embodiment of the present invention.

FIG. 7B is a side view of the spacer shown in FIG. 7A.

FIG. 7C is a diagram showing a spacer and a rectangular secondary battery of a second alternative embodiment of the present invention.

FIG. 7D is a side view of the spacer shown in FIG. 7C.

FIG. 8A is a partial cross sectional diagram along a line VIA-VIA of FIG. 4A of a battery pack according to a preferred embodiment of the present invention.

FIG. 8B is a partial cross sectional diagram along a line VIA-VIA of FIG. 4A of a battery pack according to a third alternative embodiment of the present invention.

FIG. 9 is a partial cross sectional diagram along a line VIA-VIA of FIG. 4A of a battery pack according to a fourth alternative embodiment of the present invention.

FIG. 10A is a front view of a spacer used in a battery pack according to a fifth alternative embodiment of the present invention.

FIG. 10B is a back view of the spacer used in the battery pack according to the fifth alternative embodiment of the present invention.

FIG. 10C is a bottom view of the spacer used in the battery pack according to the fifth alternative embodiment of the present invention.

FIG. 10D is a plan view of the spacer used in the battery pack according to the fifth alternative embodiment of the present invention.

FIG. 10E is a right side view of the spacer used in the battery pack according to the fifth alternative embodiment of the present invention.

FIG. 10F is a left side view of the spacer used in the battery pack according to the fifth alternative embodiment of the present invention.

FIG. 11A is a partial cross sectional diagram of the battery pack according to the fifth alternative embodiment of the present invention, corresponding to FIG. 8A.

FIG. 11B is a partial cross sectional diagram of the battery pack according to the fifth alternative embodiment of the present invention, corresponding to FIG. 8B.

### DESCRIPTION OF EXEMPLARY EMBODIMENTS

A preferred embodiment of the present invention will now be described in detail. The preferred embodiment(s) described below is merely exemplary for understanding of the technical idea of the present invention, and is not intended to limit the present invention to the particular embodiment(s) described herein.

As shown in FIG. 2, a rectangular secondary battery 20 has a flat-shaped winding electrode assembly 4 in which a positive electrode plate 1 and a negative electrode plate 2 are wound with a separator 3 therebetween. The outermost circumferential surface of the flat-shaped winding electrode assembly 4 is covered by the separator 3.

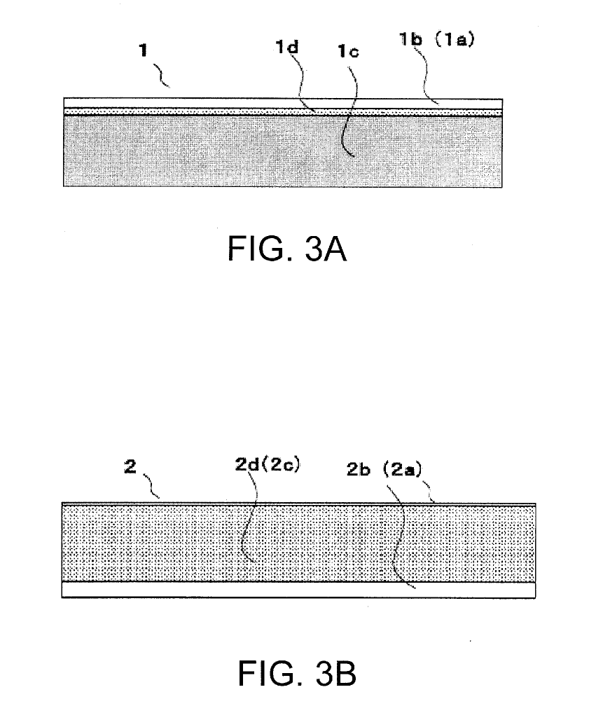

As shown in FIG. 3A, in the positive electrode plate 1, a positive electrode mixture layer 1c is formed over both surfaces of a positive electrode core 1a made of aluminum such that positive electrode core exposed portions 1b where a core is exposed in a band shape along a longitudinal direction at an end of one side in a width direction are formed over both surfaces. Over the positive electrode core 1a near the end of the positive electrode mixture layer 1c, a positive electrode protection layer 1d is formed. As shown in FIG. 3B, in the negative electrode plate 2, a negative electrode mixture layer 2c is formed over both surfaces of a negative electrode core 2a made of copper such that negative electrode core exposed portions 2b where a core is exposed in a band shape along a longitudinal direction on both ends in a width direction are formed over both surfaces. A negative electrode protection layer 2d is formed over the negative electrode mixture layer 2c. A width of the negative electrode core exposed portion 2b provided on one end in the width direction of the negative electrode plate 2 is wider than a width of the negative electrode core exposed portion 2b provided on the other end in the width direction of the negative electrode plate 2. Alternatively, the negative electrode core exposed portion 2b may be provided on only one end in the width direction of the negative electrode plate 2.

The positive electrode plate 1 and the negative electrode plate 2 are wound with the separator 3 therebetween, and formed in a flat shape, so that the flat-shaped winding electrode assembly 4 is produced. In this process, the positive electrode core exposed portion 1b which is wound is formed on one end of the flat-shaped winding electrode assembly 4, and the negative electrode core exposed potion 2b which is wound is formed on the other end.

The wound positive electrode core exposed portion 1b is electrically connected to a positive electrode terminal 6 via a positive electrode electricity collector 5. The wound negative electrode core exposed portion 2b is electrically connected to a negative electrode terminal 8 via a negative electrode electricity collector 7. The positive electrode electricity collector 5 and the positive electrode terminal 6 are preferably made of aluminum. The negative electrode electricity collector 7 and the negative electrode terminal 8 are preferably made of copper. The positive electrode terminal 6 preferably includes a connection section 6a penetrating through a sealing plate 11 made of a metal, a plate-shaped section 6b placed on an outer surface side of the sealing plate 11, and a bolt section 6c provided over the plate-shaped section 6b. The negative electrode terminal 8 preferably includes a connection section 8a penetrating through the sealing plate 11, a plate-shaped section 8b placed at an outer surface side of the sealing plate 11, and a bolt section 8c provided over the plate-shaped section 8b.

On an electricity conduction path between the positive electrode plate 1 and the positive electrode terminal 6, a current disconnection mechanism 16 is provided which is activated when an inner pressure of the battery becomes larger than a predetermined value to disconnect the electricity conduction path between the positive electrode plate 1 and the positive electrode terminal 6.

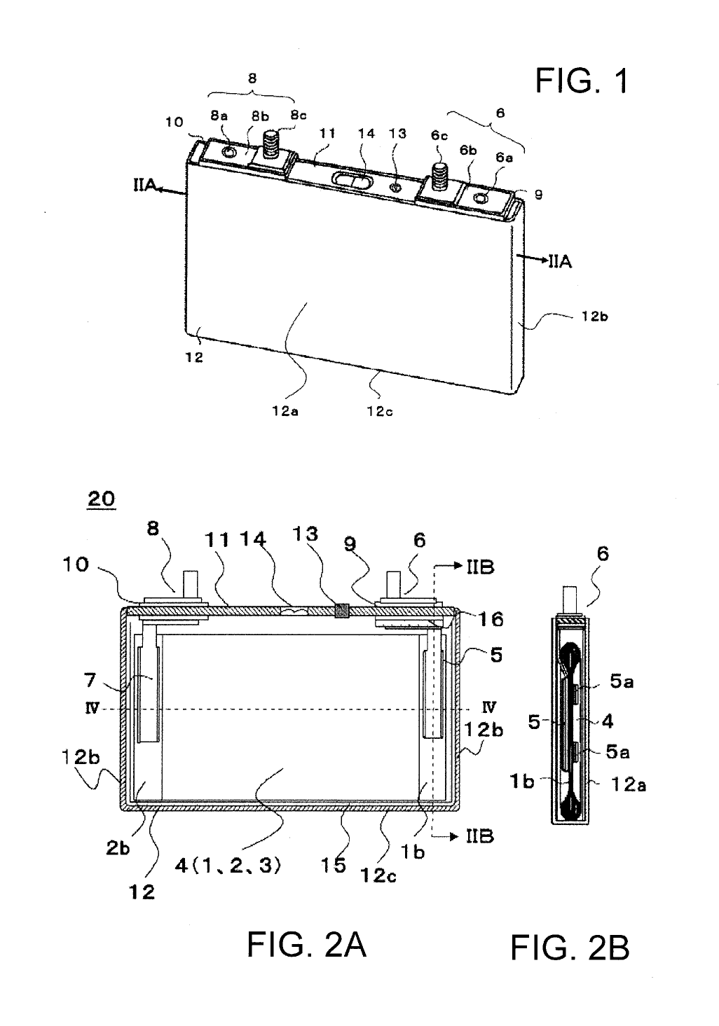

As shown in FIGS. 1 and 2A, the positive electrode terminal 6 is fixed on the sealing plate 11 with an insulating member 9 therebetween. The negative electrode terminal 8 is fixed on the sealing plate 11 with an insulating member 10 therebetween.

The flat-shaped winding electrode assembly 4 is housed in a rectangular outer housing 12 in a state of being covered with an insulating sheet 15 made of a resin. The sealing plate 11 is brought into contact with an opening of the rectangular outer housing 12, and the contact section between the sealing plate 11 and the rectangular outer housing 12 is laser-welded.

The rectangular outer housing 12 has a tubular shape with a bottom, and includes a pair of large-area side walls 12a, a pair of small-area side walls 12b having a smaller area than the large-area side walls 12a, and a bottom 12c. On a flat section of the flat-shaped winding electrode assembly 4, a pair of flat outer surfaces are placed to oppose the pair of the large-area side walls 12a, respectively.

The sealing plate 11 has an electrolytic solution injection hole 13, a non-aqueous electrolytic solution is introduced through the electrolytic solution injection hole 13, and then, the electrolytic solution injection hole 13 is sealed by a blind rivet or the like. On the sealing plate 11, a gas discharge valve 14 is formed which breaks when an inner pressure of the battery becomes a larger value than an activation pressure of the current disconnection mechanism 16 to discharge the gas inside the battery to the outside of the battery.

Next, manufacturing methods of the positive electrode plate 1, the negative electrode plate 2, the flat-shaped winding electrode assembly 4, and non-aqueous electrolytic solution serving as the non-aqueous electrolyte in the rectangular secondary battery will be described.

### [Production of Positive Electrode Plate]

As the positive electrode active material, a lithium transition metal complex oxide represented by Li(Ni_{0.35}Co_{0.35}Mn_{0.30})_{0.95}Zr_{0.05}O₂ was used. The positive electrode active material, a carbon powder serving as an electricity conducting agent, and polyvinylidene fluoride (PVdF) serving as a binding agent were prepared in an amount in mass ratio of 91:7:2, and were mixed with N-methyl-2-pyrrolidone (NMP) serving as a dispersing medium, to produce a positive electrode mixture slurry.

An alumina powder, the PVdF, a carbon powder, and the NMP serving as the dispersing medium were mixed in an amount in mass ratio of 21:4:1:74, to produce a positive electrode protection layer slurry.

The positive electrode mixture slurry produced by the above-described method was applied on both surfaces of an aluminum foil serving as the positive electrode core 1a and having a thickness of 15 μm by a die coater. Then, the positive electrode protection layer slurry produced by the above-described method was applied over the positive electrode core 1a at an end of the region in which the positive electrode mixture slurry was applied. Then, the electrode plate was dried to remove the NMP serving as the dispersing medium, and the structure was compressed by a roll press to a predetermined thickness. The resulting structure was cut in a predetermined size such that the positive electrode core exposed portion 1b in which the positive electrode mixture layer 1c was not formed on both surfaces along a longitudinal direction was formed on one end in a width direction of the positive electrode plate 1, to form the positive electrode plate 1.

### [Production of Negative Electrode Plate]

A graphite powder serving as the negative electrode active material, carboxymethyl cellulose (CMC) serving as a viscosity enhancing agent, and styrene-butadiene rubber (SBR) serving as a binding agent were prepared in an amount in mass ratio of 98:1:1, and mixed with water serving as a dispersing medium, to produce a negative electrode mixture slurry.

An alumina powder, a binding agent (acrylic resin), and the NMP serving as a dispersing medium were mixed in an amount in mass ratio of 30:0.9:69.1, to produce a negative electrode protection layer slurry to which a mixture dispersion process was applied by a beads mill.

The negative electrode mixture slurry produced by the above-described method was applied to both surfaces of a copper foil serving as the negative electrode core 2a and having a thickness of 8 μm by a die coater. Then, the structure was dried to remove the water serving as the dispersing medium, and was compressed by a roll press to a predetermined thickness. Then, the negative electrode protection layer slurry produced by the above-described method was applied over the negative electrode mixture layer 2c, and the NMP used as a solvent was dried and removed, to produce the negative electrode protection layer. Then, the structure was cut in a predetermined size such that the negative electrode core exposed portion 2b where the negative electrode mixture layer 2c was not formed on both surfaces along a longitudinal direction was formed on both ends in a width direction of the negative electrode plate, to produce the negative electrode plate 2.

### [Production of Flat-Shaped Winding Electrode Assembly]

The positive electrode plate 1 and the negative electrode plate 2 produced by the above-described methods were wound with the separator 3 made of polypropylene and having a thickness of 20 μm therebetween, and then molded in a flat shape, to produce the flat-shaped winding electrode assembly 4. This process was executed in a manner such that, on one end in a winding axis direction of the flat-shaped winding electrode assembly 4, the wound positive electrode core exposed portion 1b was formed, and on the other end, the negative electrode core exposed portion 2b was formed. The separator 3 was positioned at the outermost circumference of the flat-shaped winding electrode assembly 4. In addition, a winding termination end of the negative electrode plate 2 was positioned at a more outer circumferential side than a winding termination end of the positive electrode plate 1.

### [Preparation of Non-Aqueous Electrolytic Solution]

A mixture solvent was produced in which ethylene carbonate (EC), ethylmethyl carbonate (EMC), and diethyl carbonate (DEC) were mixed in a volume ratio (25° C., 1 atmosphere) of 3:3:4. To this mixture solvent, LiPF₆ was added to a concentration of 1 mol/L, and 1.0 weight %, with respect to the total mass of the non-aqueous electrolyte, of lithium fluorosulfonic acid and 0.3 weight % of vinylene carbonate (VC) were added, to produce a non-aqueous electrolytic solution.

### [Assembly of Rectangular Secondary Battery]

The positive electrode terminal 6 and the positive electrode electricity collector 5 were electrically connected, and were fixed on the sealing plate 11 made of aluminum with the insulating member 9 therebetween. In addition, the current disconnection mechanism 16 that disconnects the electricity conduction path between the positive electrode terminal 6 and the positive electrode electricity collector 5 when the inner pressure of the battery becomes larger than a predetermined value was provided between the positive electrode terminal 6 and the positive electrode electricity collector 5. The negative electrode terminal 8 and the negative electrode electricity collector 7 were electrically connected, and were fixed on the sealing plate 11 with the insulating member 10 therebetween. Then, the positive electrode electricity collector 5 and a mounting component 5a were connected to the outermost surface of the wound positive electrode core exposed portion 1b, and the negative electrode electricity collector 7 and a mounting component were connected to the outermost surface of the negative electrode core exposed portion 2b.

Then, the flat-shaped winding electrode assembly 4 was covered with the insulating sheet 15 made of polypropylene and folded and molded in a box shape, and the resulting structure was inserted into the rectangular outer housing 12 made of aluminum. The contact section between the rectangular outer housing 12 and the sealing plate 11 were laser-welded, to seal the opening of the rectangular outer housing 12.

After the non-aqueous electrolytic solution produced by the above-described method was introduced from the electrolytic solution injection hole 13 of the sealing plate 11, the electrolytic solution injection hole 13 was sealed with a blind rivet, to form a battery I.

A non-aqueous electrolytic secondary battery having a similar structure to that of the battery I except that lithium fluorosulfonic acid was not added to the non-aqueous electrolyte was produced and set as a battery II.

For the battery I and battery II produced by the above-described methods, a high-temperature storage characteristic was measured in the following manner.

[Measurement of after-High-Temperature-Storage Capacity Maintenance Ratio]

The battery was charged to 4.1 V at a constant current of 1 C under a condition of 25° C. After the battery was charged for 2 hours at 4.1 V, the battery was discharged to 3 V at a constant current of ½ C, and was discharged for 3 hours at 3 V. The discharge capacity in this process was set as a before-storage capacity. Then, the battery was charged to the SOC of 80% at a constant current of 1 C, and stored for 40 days at 60° C. After the storage, the battery was charged to 4.1 V at a constant current of 1 C. After the battery was charged for 2 hours at 4.1 V, the battery was discharged to 3V at a constant current of ½ C, and discharged for 3 hours at 3 V. A discharge capacity in this process was set as an after-storage capacity. An after-storage capacity maintenance ratio was calculated by the following equation:

After-storage capacity maintenance ratio (%)=after-storage capacity/before-storage capacity×100

### [Measurement of Battery Expansion Rate]

After the battery was charged to the SOC of 80% at a constant current of 1 C and a temperature of 25° C., a thickness of the center section of the battery was measured. Then, the battery was stored for 1 week at 60° C. After the storage, the thickness of the center section of the battery was measured. A battery expansion rate was calculated from the following equation:

Battery expansion rate (%)=after-storage battery thickness/before-storage battery thickness×100

TABLE 1 shows the result of the above-described measurements.

TABLE 1

| | | AFTER-STORAGE | |
|---|---|---|---|
| | | CAPACITY | BATTERY |
| | FSO₃Li | MAINTENANCE | EXPANSION |
| | ADDITION | RATIO (%) | RATE (%) |
| BATTERY I | ADDED | 92 | 118 |
| BATTERY II | NOT ADDED | 89 | 126 |

As shown in TABLE 1, when lithium fluorosulfonic acid is added to the non-aqueous electrolyte, a rectangular secondary battery having a superior high-temperature storage characteristic can be obtained.

Next, a battery pack 30 according to a preferred embodiment of the present invention will be described.

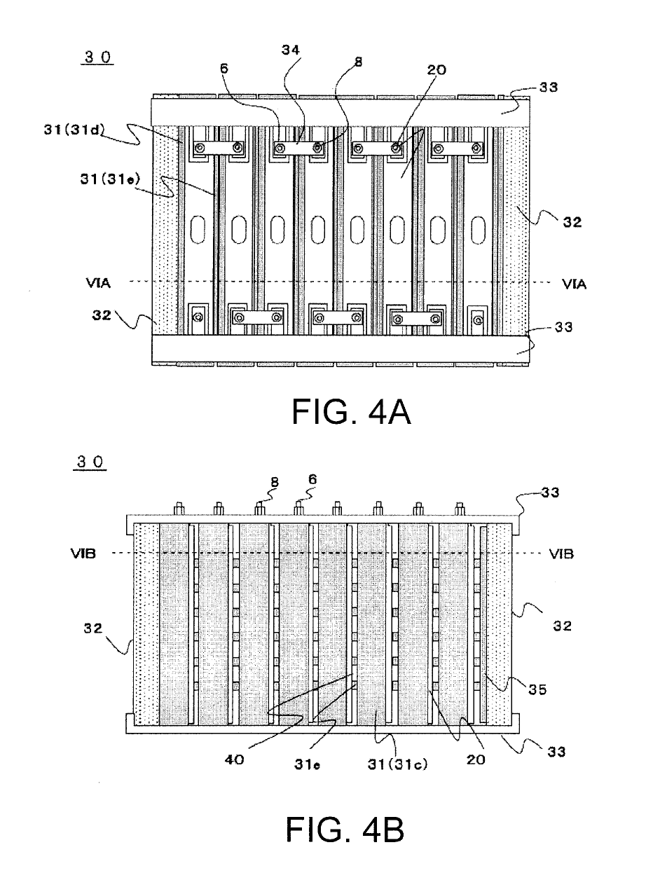

As shown in FIGS. 4A and 4B, in the battery pack 30, a plurality of rectangular secondary batteries 20 produced by the above-described method are layered with a spacer 31 made of a resin therebetween, between a pair of end plates 32. A bind bar 33 has both ends connected respectively to the end plates 32, and the rectangular secondary batteries 20 are held between the pair of the end plates 32. An insulating plate 35 made of a resin is placed between one end plate and a rectangular secondary battery 20 at an end in the layering direction. Two bind bars 33 are placed on a surface on a side of the sealing plate 11, and two bind bars 33 are placed on the side of the bottom 12c of the rectangular outer housing 12. Preferably, the end plate 32 and the bind bar 33 are connected by a bolt or the like. The positive electrode terminal 6 and the negative electrode terminal 8 of each rectangular secondary battery 20 is placed on the same surface of the battery pack 30. The positive electrode terminal 6 and the negative electrode terminal 8 of adjacent rectangular secondary batteries 20 are connected to each other by a bus bar 34. A gap is formed between the spacer 31 and one large-area side wall 12a of the rectangular secondary battery 20, and is hereinafter referred to as a flow path 40. By supplying a cooling medium such as cooling gas to the flow path 40, the rectangular secondary battery 20 can be effectively cooled.

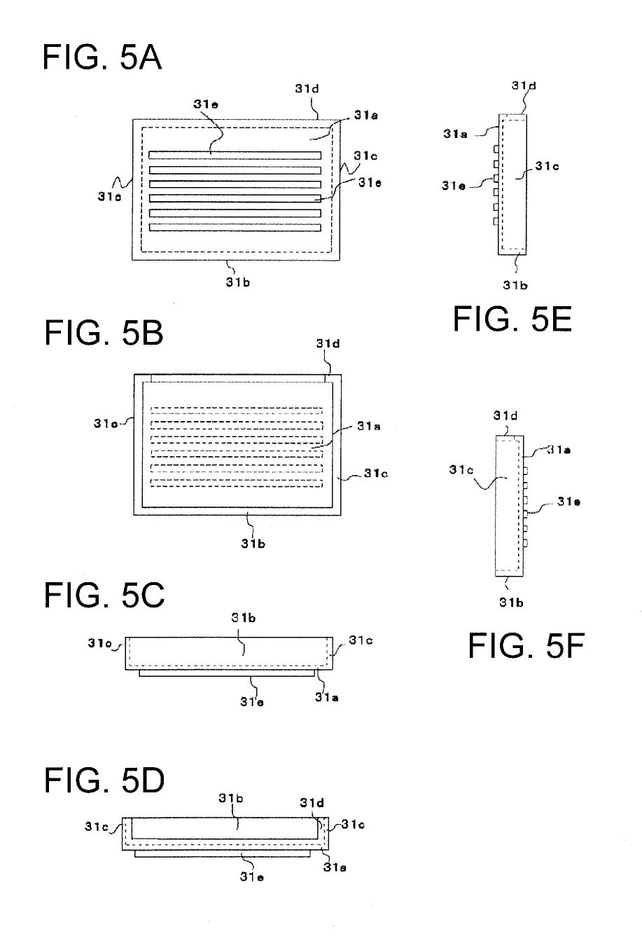

As shown in FIGS. 5A˜5F, 6A, and 6B, the spacer 31 used in the battery pack 30 preferably comprises a body section 31a, a lower wall section 31b, a side wall section 31c, and an upper wall section 31d. The body section 31a is placed between the respective large-area side walls 12a of adjacent rectangular secondary batteries 20. The lower wall section 31b extends from the body section 31a in a vertical direction with respect to the body section 31a, and is placed to oppose the bottom 12c of the rectangular outer housing 12. The side wall section 31c extends from the body section 31a in a vertical direction with respect to the body section 31a, and is placed to oppose the small-area side wall 12b of the rectangular outer housing 12. The upper wall section 31d extends from the body section 31a of the spacer 31 in a vertical direction with respect to the body section 31a, and is placed to oppose the sealing plate 11. A plurality of projections 31e are provided on one surface of the body section 31a. The projection 31e is formed to extend in a width direction of the body section 31a. In the battery pack 30, the projection 31e is provided in a line shape to extend in a direction of extension of the winding axis of the winding electrode assembly 4. Alternatively, a cutout section or an opening may be provided in at least one of the body section 31a, the lower wall section 31b, the side wall section 31c, and the upper wall section 31d.

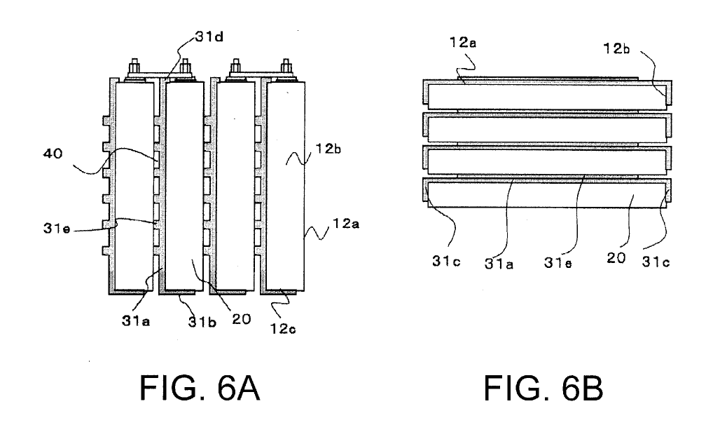

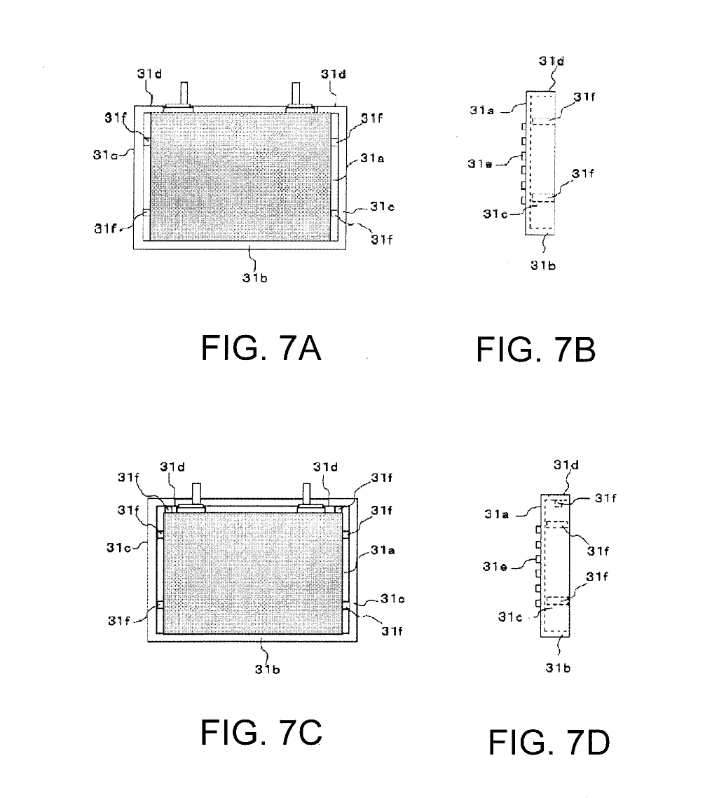

As shown in FIG. 6B, the pair of the side wall sections 31c of the spacer 31 are placed to respectively oppose the pair of the small-area side walls 12b of the rectangular secondary battery 20. Therefore, in the assembly process of the battery pack and processes thereafter, it is possible to inhibit damage to the small-area side wall 12b of the rectangular secondary battery 20. In addition, the small-area side wall 12b of the rectangular secondary battery 20 and an inner surface of the side wall section 31c may be brought into contact with each other directly or via an insulating sheet or the like, so that the rectangular secondary battery 20 can be positioned on the inner surface of each of the pair of the side wall sections 31c. With such a configuration, position deviation in a lateral direction of the rectangular secondary battery 20 can be prevented in the battery pack 30. Alternatively, as shown in FIG. 7A, a projection 31f may be provided on at least one inner surface of the pair of the side wall sections 31c of the spacer 31 so that the projection 31f is in contact with the small-area side wall 12b of the rectangular secondary battery 20 directly or via an insulating sheet or the like.

As shown in FIG. 6A, the lower wall section 31b of the spacer 31 is placed to oppose the bottom 12c of the rectangular secondary battery 20. Therefore, it is possible to inhibit damage to the bottom 12c of the rectangular secondary battery 20 in the assembly process of the battery pack and processes thereafter. Alternatively, the upper wall section 31d may be provided on the spacer 31 so that the inner surface of the lower wall section 31b and the inner surface of the upper wall section 31d are in contact respectively with the bottom 12c of the rectangular secondary battery 20 and an upper end of the sealing plate 11 or the small-area side wall 12b directly or via an insulating sheet or the like, to position the rectangular secondary battery 20 on the inner surfaces of the upper wall section 31d and the lower wall section 31b, respectively. With such a configuration, position deviation in the up-and-down direction of the rectangular secondary battery 20 can be prevented in the battery pack 30. Alternatively, as shown in FIG. 7B, a projection 31f may be provided on at least one inner surface of the lower wall section 31b and the upper wall section 31d of the spacer 31, so that the projection 31f is in contact with the upper end of the sealing plate 11 or the small-area side wall 12b, or the bottom 12c of the rectangular outer housing 12 directly or via an insulating sheet or the like.

An area of a region, of the bottom 12c of the rectangular outer housing 12, opposed by the lower wall section 31b of the spacer 31, is preferably greater than or equal to 20% with respect to a total area of the bottom 12c of the rectangular outer housing 12, more preferably, greater than or equal to 40%, and even more preferably, greater than or equal to 80%. In addition, an area of a region, of the small-area side wall 12b of the rectangular outer housing 12, opposed by the side wall section 31c of the spacer 31, is preferably greater than or equal to 20% with respect to a total area of the small-area side wall 12b of the rectangular outer housing 12, more preferably, greater than or equal to 40%, and even more preferably, greater than or equal to 60%. In addition, the area is preferably less than or equal to 98%. Furthermore, an area of a region, of the sealing plate 11 of the rectangular secondary battery 20, opposed by the upper wall section 31d of the spacer 31 is preferably greater than or equal to 5% with respect to a total area of the sealing plate 11.

In the battery pack 30, although damage to the rectangular Outer housing 12 of the rectangular secondary battery 20 can be prevented when the bottom 12c and the small-area side wall 12b of the rectangular secondary battery 20 are covered by the spacer 31 as described above, the rectangular secondary battery 20 tends to more easily be held in a high-temperature state. When a high-temperature held state of the rectangular secondary battery 20 is continued, reduction of the battery characteristic tends to more easily occur. In the battery pack 30 of the present embodiment, because lithium fluorosulfonic acid is added to the non-aqueous electrolyte included in the rectangular secondary battery 20, even when the rectangular secondary battery 20 is held in the high-temperature state, the reduction of the battery characteristic can be prevented. Therefore, the battery pack of the present embodiment is a battery pack having a very high reliability.

As shown in FIGS. 6A and 6B, a tip portion of the projection 31e provided on one surface of the spacer 31 presses one large-area side wall 12a of the rectangular outer housing 12. On the other surface of the spacer 31, the projection 31e is not provided, and the body section 31a presses the other large-area side wall 12a of the rectangular outer housing 12 in a planar manner. Therefore, one surface of the spacer 31 on which the projection 31e is formed and the other surface of the spacer 31 on which the projection 31e is not formed have different pressing areas of the large-area side walls 12a of the rectangular outer housing 12 respectively opposing these surfaces.

Here, the area in which one surface of the spacer 31 presses the large-area side wall 12a of the rectangular outer housing 12 which the one surface opposes is preferably less than or equal to 50% of a total area of the large-area side wall 12a of the rectangular outer housing 12a opposed by the one surface of the spacer 31, and more preferably less than or equal to 30%. In addition, the area is preferably greater than or equal to 5%.

Similarly, an area in which the other surface of the spacer 31 presses the large-area side wall 12a of the rectangular outer housing 12 which the other surface opposes is preferably greater than or equal to 60% of a total area of the large-area side wall 12a of the rectangular housing 12 opposed by the other surface of the spacer 31, and more preferably greater than or equal to 70%. On the other surface of the spacer 31, it is not necessary that the entire surface of the large-area side wall 12a of the rectangular outer housing 12 is in contact with the body section 31a. A recess or an opening may be formed in a part of the body section 31a, to provide a portion which is not pressed, in the large-area side wall 12a of the rectangular outer housing 12. Alternatively, an outer circumference of the rectangular outer housing 12 may be covered with an insulating sheet or the like and the spacer 31 may press the rectangular outer housing 12 via the insulating sheet.

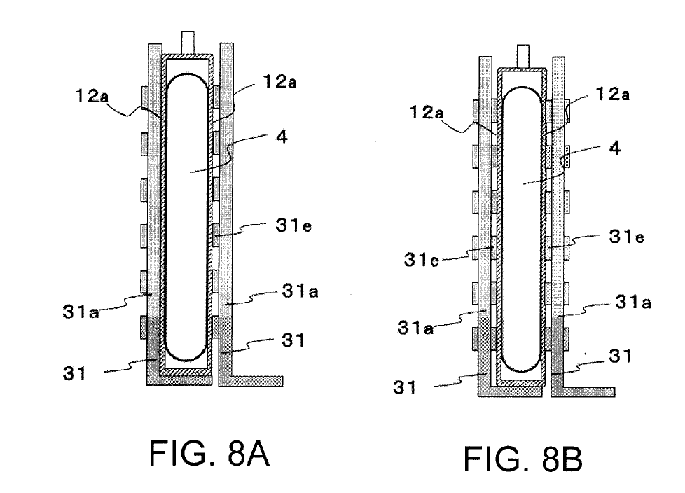

When both sides of the pair of the large-area side walls 12a of the rectangular secondary battery 20 are pressed by the spacers 31 where the projections 31e are respectively formed as shown in FIG. 8B, a difference in the pressing force tends to become large between a portion where the winding electrode assembly 4 is partially pressed strongly and the other portions. Thus, there is a possibility that the battery characteristic such as the cycle characteristic will be reduced. In contrast, when one large-area side wall 12a of the rectangular secondary battery 20 is pressed by the projection 31e and the other large-area side wall 12a is pressed in plane by the body section 31a of the spacer 31 as shown in FIG. 8A, the variation due to the position of the pressing force with respect to the winding electrode assembly 4 can be reduced, and thus, such a configuration is preferable.

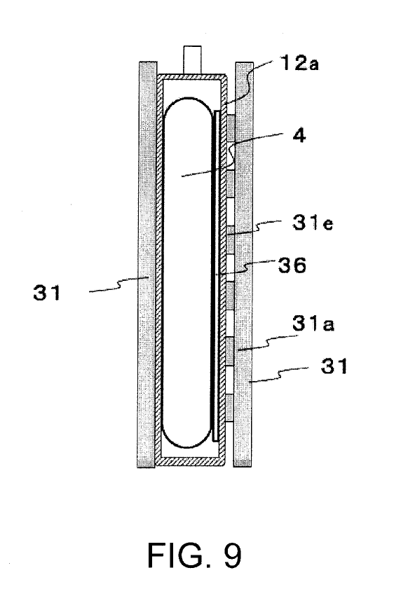

Alternatively, a configuration may be employed as shown in FIG. 9 in which one large-area side wall 12a of the rectangular secondary battery 20 is pressed by the projection 31e, the other large-area side wall 12a is pressed in a planar manner by the body section 31a of the spacer 31, and a metal plate 36 is placed between the winding electrode assembly 4 and the large-area side wall 12a. With such a configuration, the winding electrode assembly 4 can be more uniformly pressed. As the metal plate 36, a stainless steel plate, an aluminum plate, a copper plate, or the like may be used. The use of the copper plate is particularly preferable. The metal plate 36 may be electrically connected to the positive electrode plate or the negative electrode plate. The metal plate 36 preferably has a larger thickness than the core included in the positive electrode plate and the negative electrode plate, and is preferably thicker than the positive electrode plate and the negative electrode plate.

### [Alternative Configurations]

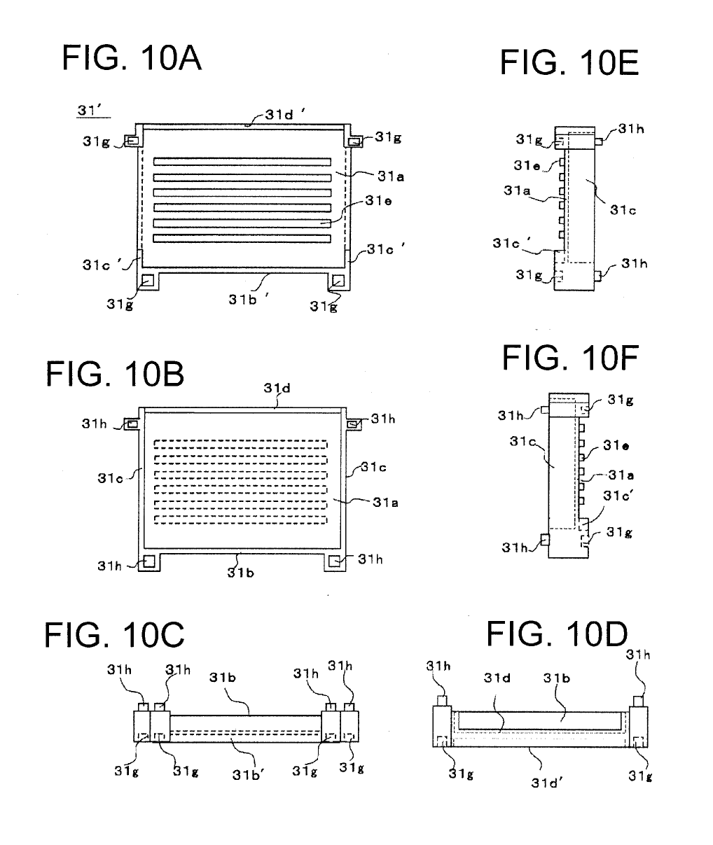

FIG. 10 is a diagram showing a spacer 31′ used in a battery pack of an alternative configuration. The spacer 31′ of the alternative configuration may be employed in place of the spacer 31 used in the battery pack 30 of the preferred embodiment of the present invention. In the spacer 31′, on a surface opposite from the surface on which the lower wall section 31b, the side wall section 31c, and the upper wall section 31d are formed on the body section 31a, a second lower wall section 31b′, a second side wall section 31c′, and a second upper wall section 31d′ are formed.

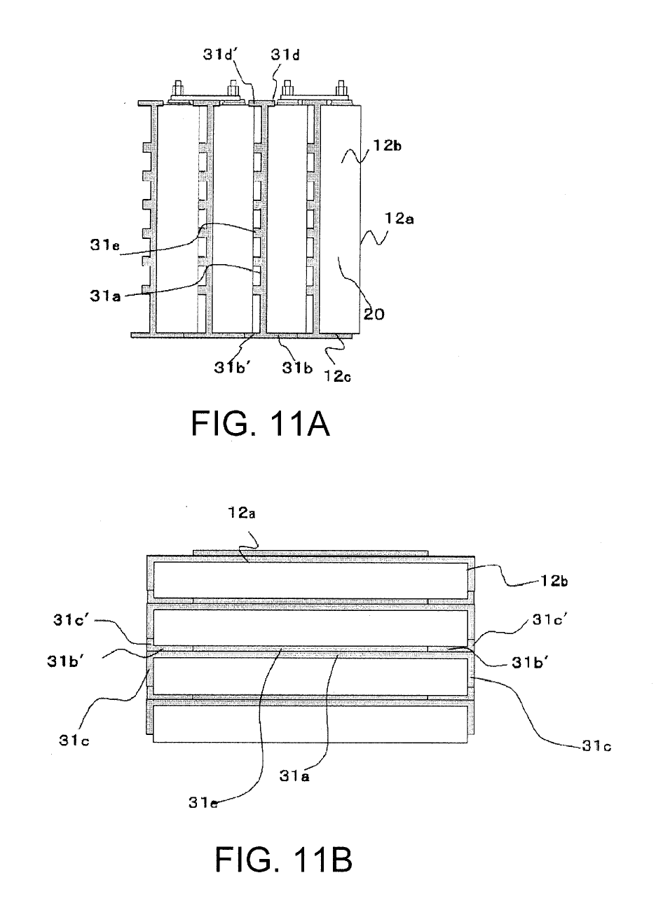

As shown in FIGS. 11A and 11B, the second lower wall section 31b′, the second side wall section 31c′, and the second upper wall section 31d′ are placed to respectively oppose the bottom 12c of the rectangular secondary battery 20, the small-area side wall 12b, and the sealing plate 11.

As shown in FIGS. 10A and 10B, on one surface side of the spacer 31′, a fitting recess 31g is provided below the second lower wall section 31b′ and on an outer side of the second side wall section 31c′. In addition, on the other surface side of the spacer 31′, a fitting projection 31h is provided below the lower wall section 31b and on an outer side of the side wall section 31c. The fitting projection 31h is fitted to the fitting recess 31g at a corresponding position. The shape of the fitting section provided in the spacer is not limited to the above-described shapes, and other shapes may be employed.

A battery III and a battery IV were produced by a method similar to the above-described method for the battery I, except that the content of lithium fluorosulfonic acid in the non-aqueous electrolyte with respect to the total mass of the non-aqueous electrolyte was set to 2 weight % and 4 weight %, respectively. For the batteries III and IV, the after-storage capacity maintenance ratio was measured by a method similar to the above-described method, except that the storage period at 60° C. was changed from 40 days to 20 days. TABLE 2 shows the results.

TABLE 2

| | AMOUNT OF | AFTER-STORAGE |
|---|---|---|
| | ADDED FSO₃Li | CAPACITY MAINTENANCE |
| | (WEIGHT %) | RATIO (%) |
| BATTERY III | 2.0 | 94.9 |
| BATTERY IV | 4.0 | 93.0 |

The batteries III and IV using non-aqueous electrolyte including FSO₃Li may be expected to have a higher capacity maintenance ratio after storage at a high temperature than a battery which uses non-aqueous electrolyte which does not include FSO₃Li.

A battery V was produced through a method similar to that for the battery I except that the content of lithium fluorosulfonic acid in the non-aqueous electrolyte with respect to the total mass of the non-aqueous electrolyte was set to 0.5 weight %. For the batteries V, I, and III, the after-storage capacity maintenance ratio was measured by a method similar to the above except that the storage period at 60° C. was changed from 40 days to 180 days. In addition, after-storage normal temperature discharge resistance/normal temperature resistance increase ratio (25° C., SOC of 56%) were measured through the following methods.

[Measurement of after-Storage Normal Temperature Discharge Resistance/Normal Temperature Resistance Increase Ratio (25° C., SOC of 56%)]

The battery was charged to 4.1 V at a constant current of 1 C and a temperature of 25° C. After the battery was charged for 2 hours at 4.1 V, the battery was discharged to 3 V at a constant current of ½ C, and discharged for 3 hours at 3 V. The battery was then charged to a state of charge (SOC) of 56% at a constant current of 1 C and a temperature of 25° C. Then, the battery was discharged for 10 seconds at a constant current of 45 C and a temperature of 25° C., a graph was plotted with the voltages before and after the discharge on the y-axis and the current on the x-axis, and a slope thereof was set as a before-storage normal temperature resistance. Then, the battery was charged to a SOC of 80% at a constant current of 1 C, and was stored for 180 days at 60° C. After the storage, the battery was discharged to 3 V at a constant current of ½ C and a temperature of 25° C., discharged for 3 hours at 3 V, and then charged to a state of charge (SOC) of 56% at a constant current of 1 C. Then, the battery was discharged for 10 seconds at a constant current of 45 C and a temperature of 25° C., a graph was plotted with the voltages before and after the discharge on the y-axis and the current on the x-axis, and a slope thereof was set as an after-storage normal temperature resistance. In addition, a ratio of the after-storage normal temperature resistance with respect to the before-storage normal temperature resistance was set as a normal temperature resistance increase ratio.

TABLE 3 shows results of the measurements of the after-storage capacity maintenance ratio, and the after-storage normal temperature resistance/normal temperature resistance increase ratio (25° C., SOC of 56%). With regard to the normal temperature resistance increase ratio, the measured value for the battery I was set as 100%, and relative values of the measured values for the batteries V and III with respect to the measured value for the battery I are shown.

TABLE 3

| | | | 25° C. SOC56% |
|---|---|---|---|
| | | | NORMAL |
| | AMOUNT OF | AFTER-STORAGE | TEMPERATURE |
| | ADDED | CAPACITY | RESISTANCE |
| | FSO₃Li | MAINTENANCE | INCREASE |
| | (WEIGHT %) | RATIO (%) | RATIO (%) |
| BATTERY V | 0.5 | 84 | 108 |
| BATTERY I | 1.0 | 86 | 107 |
| BATTERY III | 2.0 | 85 | 105 |

It can be expected that the batteries V, I, and III which use the non-aqueous electrolyte including FSO₃Li have a higher capacity maintenance ratio after high-temperature storage, and a lower increase of resistance due to the high-temperature storage compared to a battery which uses non-aqueous electrolyte which does not include FSO₃Li.

### <Others>

As the positive electrode active material, lithium transition metal complex oxides may be preferably used. As the lithium transition metal complex oxide, lithium cobalt oxide (LiCoO₂), lithium manganate (LiMn₂O₄), lithium nickel oxide (LiNiO₂), lithium nickel manganese complex oxide (LiNi₁₋ₓMnₓO₂ (0<x<1)), lithium nickel cobalt complex oxide (LiNi₁₋ₓCoₓO₂ (0<x<1)), and lithium nickel cobalt manganese complex oxide (LiNiₓCo_{y}Mn_{z}O₂ (0<x<1, 0<y<1, 0<z<1, x+y+z=1)) may be exemplified. In addition, the above-described lithium transition metal complex oxide doped with Al, Ti, Zr, Nb, B, Mg, or Mo or the like may alternatively be used. For example, lithium transition metal complex oxide may be exemplified by Li₁₊ₐNiₓCo_{y}Mn_{z}M_{b}O₂ (M=at least one element selected from Al, Ti, Zr, Nb, B, W, Mg, and Mo, 0≦a≦0.2, 0.2≦x≦0.5, 0.2≦y≦0.5, 0.2≦z≦0.4, 0≦b≦0.02, a+b+x+y+z=1).

As the negative electrode active material, a carbon material which can occlude and discharge lithium ions is preferably used. Carbon materials which can occlude and discharge lithium ions include graphite, a hardly graphitizing carbon, an easily graphitizing carbon, fiber carbon, cokes, and carbon black. Of these, the graphite is particularly preferable. As a non-carbon-based material, silicon, tin, and an alloy and an oxide having silicon and tin as primary constituent may be exemplified.

As the non-aqueous solvent (organic solvent) of the non-aqueous electrolyte, carbonates, lactones, ethers, ketones, esters, or the like may be used. Alternatively, two or more of these solvents may be used in a mixture. For example, ring carbonates such as ethylene carbonate, propylene carbonate, and butylene carbonate, or chain carbonates such as dimethyl carbonate, ethylmethyl carbonate, and diethyl carbonate may be used. In particular, the use of a mixture solvent of the ring carbonate and the chain carbonate is preferable. In addition, an unsaturated ring ester carbonate such as vinylene carbonate (VC) may be added to the non-aqueous electrolyte.

As electrolyte salts of the non-aqueous electrolyte, materials generally used as the electrolyte salt in the lithium ion secondary battery of the related art may be used. For example, LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, or LiP(C₂O₄)F₄, or a mixture thereof may be used. Of these, LiPF₆ is particularly preferable. In addition, the dissolved amount of the electrolyte salt in the non-aqueous solvent is preferably 0.5˜2.0 mol/L.

As the separator, a porous separator made of polyolefin may be preferably used. As the polyolefin, polypropylene (PP) and polyethylene (PE) are particularly preferable. In addition, a separator having a 3-layer structure of polypropylene (PP) and polyethylene (PE) (PP/PE/PP or PE/PP/PE) may be used. Alternatively, a polymer electrolyte may be used as the separator.

The flat-shaped electrode assembly may be a layered electrode assembly in which a plurality of positive electrode plates, a plurality of the negative electrode plates, and the separator are layered.

In the battery pack, the rectangular secondary battery is preferably constrained with a constraining force of 900˜1000 kgf.

What is claimed is:

1. A battery pack in which a plurality of rectangular secondary batteries are layered between a pair of end plates with an insulating spacer therebetween, wherein
the rectangular secondary battery comprises:
a positive electrode plate including a positive electrode active material to and from which lithium ions may be introduced and extracted;
a negative electrode plate including a negative electrode active material to and from which lithium ions may be introduced and extracted;
a flat-shaped electrode assembly in which the positive electrode plate and the negative electrode plate are layered with a separator therebetween;
a non-aqueous electrolyte including lithium fluorosulfonic acid;
a rectangular outer housing that has an opening and that houses the electrode assembly and the non-aqueous electrolyte; and
a sealing plate that seals the opening, and
the rectangular outer housing comprises a bottom, a pair of large-area side walls, and a pair of small-area side walls having a smaller area than the large-area side wall, and
the spacer comprises a body section placed between the large-area side walls of adjacent rectangular secondary batteries, a lower wall section extending from the body section in a vertical direction with respect to the body section and placed to oppose the bottom of the rectangular outer housing, and a pair of side wall sections extending from the body section in a vertical direction with respect to the body section and placed to respectively oppose the pair of the small-area side walls of the rectangular outer housing.

2. The battery pack according to claim 1, wherein the spacer further comprises an upper wall section extending from the body section in a vertical direction with respect to the body section and placed to oppose the sealing plate.

3. The battery pack according to claim 1, wherein a plurality of projections extending in a width direction of the body section are provided on one surface of the body section, and a tip surface of the projection presses the rectangular secondary battery.

4. The battery pack according to claim 3, wherein an area where one surface side of the spacer presses the large-area side wall of the rectangular secondary battery opposing the one surface is smaller than an area where the other surface side of the spacer presses the large-area side wall of the rectangular secondary battery opposing the other surface.

5. The battery pack according to claim 3, wherein the projection provided on the body section protrudes in a direction opposite to a direction of protrusion of the side wall section provided on the body section.
